(19) United States
(12) Patent Application Publication
(10) Pub. No.: US 2003/0223008 A1
(43) Pub. Date: Dec. 4, 2003

(54) Image sensor module and process of fabricating the same

(75) Inventors: Young Jun Kim, Sungnam-Shi (KR); Woo Young Choi, Suwon-Shi (KR); Na Yong Kim, Seoul (KR)

Correspondence Address: DARBY & DARBY P.C., 805 Third Avenue, New York, NY, 10022, US

(73) Assignee: SAMSUNG ELECTRO-MECHANICS CO., LTD., Kyungki-Do (KR)

(21) Appl. No.: 10/330,647

(22) Filed: Dec. 27, 2002

(30) Foreign Application Priority Data
May 28, 2002 (KR) 2002-29632

(51) Int. Cl. H04N 5/225

(52) U.S. Cl. 348/340

(57) ABSTRACT

Disclosed is an image sensor module consisting of a substrate having a hole positioned at the center thereof; an image signal process package attached to the back side of the substrate; and an image sensor mounted in the hole of the substrate, and a process of fabricating the same. In addition, a camera module is provided which consists of the image sensor module; a housing covering the upper portion of the image sensor module; a lens positioned outside of the housing; a filter positioned inside of the housing; and a flexible printed circuit board connected to the back side of the substrate of the image sensor module. The image sensor module applied to the camera module can obtain a sufficient brightness while a distance between the lens and the image sensor is properly maintained to secure a desired focal distance.

### BACKGROUND OF THE INVENTION

1. Field of the Invention

The present invention relates, in general, to a camera module applied to a digital camera and, in particular, to an image sensor module and a process of fabricating the same.

2. Description of the Prior Art

As is well known to those skilled in the art, recently, digital cameras have been widely used for internet images and communication. Particularly, demands for a small-sized camera module have increased according to widespread use of a next-generation mobile telecommunication terminal for PDA (Personal Digital Assistant) and IMT-2000 (International Mobile Telecommunication-2000). For example, a compact mobile telecommunication terminal is being increasingly applied to internet audiovisual communication. In other words, there is a great demand for slim camera modules used to produce the digital cameras with improved functions.

Particularly, it is expected that PDA terminals will be utilized as multimedia equipment using various peripheral devices such as a camera module and a mobile telecommunication module, as well as being used to check the daily schedule. Accordingly, it is necessary to provide telecommunication services capable of storing, transporting, and providing audio data, pictures, and moving pictures, and demands for compact slim camera modules will increase.

Therefore, in the case of an image sensor module using a CCD (charge coupled device) or CMOS (complementary metal oxide semiconductor) image sensor which is a basic component of the camera module, a CLCC (ceramic leadless chip carrier) or COB (chip on board) package having a hall is used to reduce the height of the module.

With reference to FIG. 1, a CCD image sensor or a CMOS image sensor is mounted on a pattern of a ceramic-PCB (printed circuit board) or an epoxy-PCB used as a substrate, the resulting structure is packaged in such a way that a housing with a filter covers the resulting structure. In addition, a lens is inserted into the resulting structure.

Because a real image can be seen by perceiving motion of the image sensor and properly treating a signal for the perceived data, an ISP package (image signal process package) in addition to the image sensor and the lens is integrated to the bottom side of the substrate or to the lateral side of the image sensor.

FIG. 1 is a sectional view of a conventional camera module. As in FIG. 1, the conventional image sensor module comprises an image sensor and an ISP package. The image sensor is attached to the upper side of a substrate 101 by a wire-bonding and the ISP package is attached to the back side of the substrate 101 to treat image signals. The image sensor module, a housing 105 covering the image sensor module, and an IR filter 104 positioned inside of the housing constitute a camera module.

In this case, however, it is difficult to reduce the height of the camera module. That is to say, the camera module cannot accomplish the recent trend of reduction in height, but the height h1 of the camera module is too high due to the ISP package. Therefore, it is difficult to minimize the height of the camera module when it is needed to accomplish compactness of the camera module.

A conventional effort has been made to avoid the above disadvantages, in which the height of the camera module is properly reduced by maintaining a short distance between the upper side of the lens and the image sensor. However, this conventional effort is disadvantageous in that it greatly broadens a refracting angle of an incidence beam, and so a circumferential light quantity ratio of a camera module lens is poorer than a central light quantity ratio, thereby reducing the optical performance of the lens.

### SUMMARY OF THE INVENTION

Therefore, it is an object of the present invention to avoid the above disadvantages, and to provide a novel camera module, the height of which is desirably lowered while a desired distance between an upper side of a lens and an image sensor is constantly maintained without changing the optical performance of the lens.

The present invention is characterized in that the image sensor module comprises a substrate with a hole positioned at the center thereof; an image signal process package attached to the back side of the substrate; and an image sensor mounted in the hole of the substrate, and a camera module comprises the image sensor module; a housing covering the upper portion of the image sensor module; a lens positioned outside of the housing; a filter positioned inside of the housing; and a flexible printed circuit board connected to the back side of the substrate of the image sensor module.

In addition, the process of fabricating the image sensor module comprises the steps of forming a hole at the center of a substrate; attaching an image signal process package to a back side of the substrate; and adhering an image sensor to the hole positioned at the center of the substrate with the use of an adhesive and conducting a wire-bonding.

According to the second embodiment of the present invention, the image sensor module comprises a substrate with a hole positioned at the center thereof; an image signal process bare chip mounted in the hole of the substrate; and an image sensor positioned on the upper side of the image signal process bare chip and an epoxy molding compound layer encapsulating the back side of the substrate, and a camera module comprises the image sensor module; a housing covering an upper portion of the image sensor module; a lens positioned outside of the housing; a filter positioned inside of the housing; and a flexible printed circuit board connected to the back side of the substrate of the image sensor module.

Furthermore, the process of fabricating the image sensor module according to the second embodiment comprises the steps of forming a hole at the center of a substrate; inserting an image signal process bare chip into the hole of the substrate and detachably adhering a tape to the upper side of a resulting structure; conducting a wire-bonding on the back side of the substrate and encapsulating the back side of the substrate with an epoxy molding compound layer; removing the tape from a structure consisting of the image signal process bare chip and the substrate; and attaching an image sensor to the upper side of the image signal process bare chip and conducting a wire-bonding.

According to the third embodiment of the present invention, an image sensor module comprises a substrate with a hole positioned at the center thereof; a flexible printed circuit board attached to the back side of the substrate; an image signal process package attached to the back side of the flexible printed circuit board; and an image sensor mounted in the hole of the substrate, and a camera module comprises the image sensor module; a housing covering the upper portion of the image sensor module; a lens positioned outside of the housing; and a filter positioned inside of the housing. Additionally, the process of fabricating the image sensor module according to the third embodiment comprises the steps of forming a hole at the center of a substrate; attaching a flexible printed circuit board to the back side of the substrate; attaching an image signal process package to the back side of the flexible printed circuit board; and adhering an image sensor to the hole of the substrate with the use of an adhesive and conducting a wire-bonding.

### BRIEF DESCRIPTION OF THE DRAWINGS

The above and other objects, features and other advantages of the present device will be more clearly understood from the following detailed description taken in conjunction with the accompanying drawings, in which:

FIG. 1 is a sectional view of a conventional camera module;

FIG. 2 is a sectional view of a camera module according to the first embodiment of the present invention;

FIG. 3 is a sectional view of a camera module according to the second embodiment of the present invention; and

FIG. 4 is a sectional view of a camera module according to the third embodiment of the present invention.

### DETAILED DESCRIPTION OF THE INVENTION

Reference should now be made to the drawings, in which the same reference numerals are used throughout the different drawings to designate the same or similar components.

FIG. 2 is a sectional view of a camera module according to the first embodiment of the present invention. With reference to FIG. 2, the image sensor module of this invention comprises a substrate 1, an image sensor 2, and an ISP package 3. A hole for mounting the image sensor 2 is positioned at the center of the substrate 1, and the image sensor 2 is connected to the substrate 1 by a wire bonding. According to the first embodiment, the camera module comprises the image sensor module, a housing 5 covering the upper portion of the image sensor module, a hard packing 8, engaged with a screw, positioned inside of the housing 5, a lens 7 positioned inside of the hard packing 8, a knob 9 covering an end of the hard packing 8, a filter 4 positioned inside of the housing 5, and an FPCB 6 connected to a back side of the substrate 1.

A process of fabricating the image sensor module used to fabricate the camera module comprises the steps of forming the hole at the center of the substrate 1; attaching an ISP package 3 to the back side of the substrate 1 in such a way that the ISP package 3 sufficiently covers the hole; and adhering the image sensor 2 to the hole positioned at the center of the substrate 1 with the use of an adhesive and by conducting a wire-bonding.

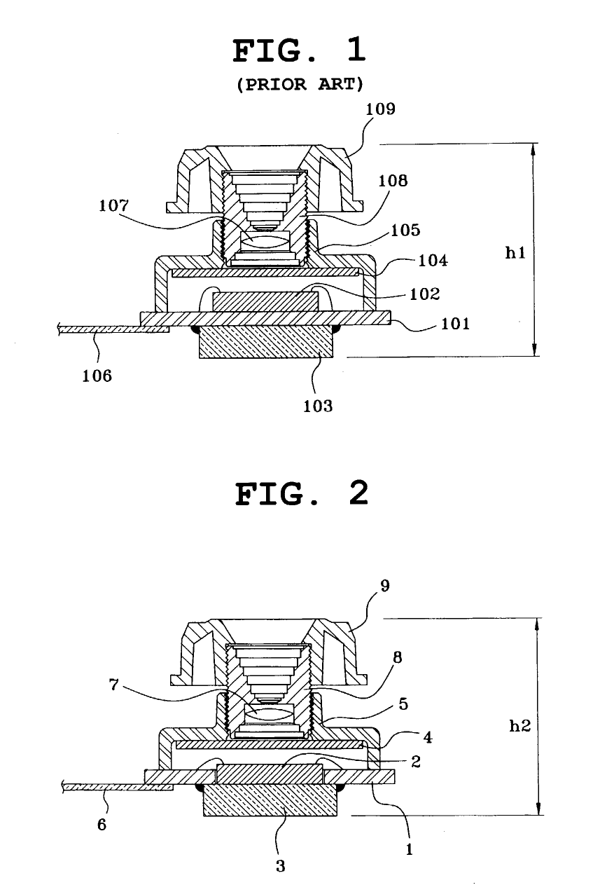

As in FIG. 2, if components constituting the camera module have the same size as those of FIG. 1, respectively, the height h2 of the camera module of FIG. 2 is lower than the height h1 of the camera module of FIG. 1, and a height difference between the two camera modules corresponds to a thickness of the substrate 1. In other words, the camera module according to the first embodiment of the present invention has a lower height than a conventional camera module because of a lowered height of the housing 5.

In the case of a conventional image sensor module, a difference between the image sensor and the substrate in a wire adhesive force occurs during a wire-bonding due to a height difference between the image sensor and the substrate, thereby reducing the wire adhesive force. However, the image sensor module of the first embodiment is advantageous in that the adhesive force is improved and the wire-bonding is conveniently conducted because of no height difference between the image sensor and the substrate.

In other words, a housing height is reduced by a thickness of the substrate 1 by forming a hole at the center of the substrate 1, so the height of the camera module can be reduced while a distance between the image sensor 2 and the lens is constantly maintained.

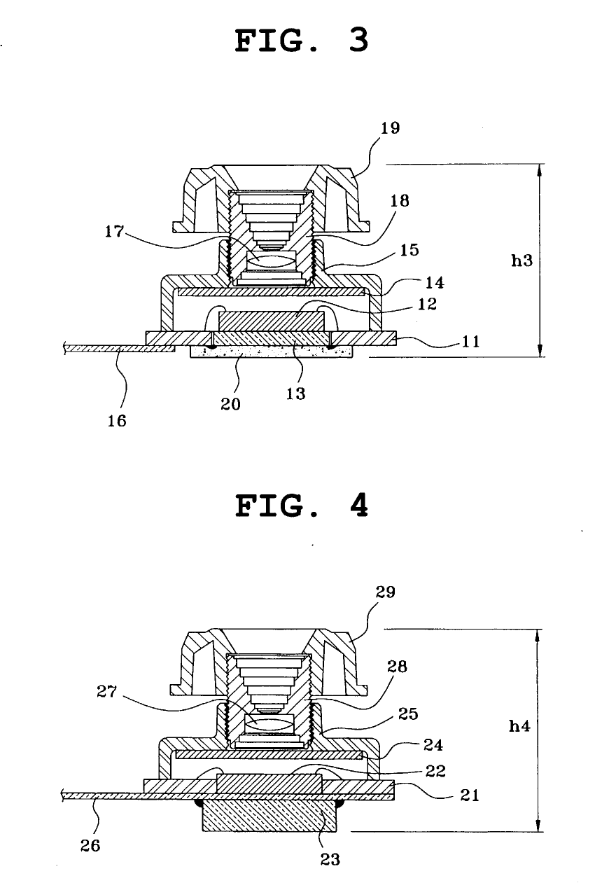

FIG. 3 is a sectional view of a camera module according to a second embodiment of the present invention. Referring to FIG. 3, the image sensor module has a hole positioned at the center of the substrate 11, and an ISP bare chip 13 is mounted on the hole. In comparison with a conventional ISP package or the ISP package according to the first embodiment of the present invention 103 and 3, the ISP bare chip of the second embodiment is characterized by its thinness because a substrate consisting of an ISP package is not needed. An image sensor 12 is positioned on the upper portion of the ISP bare chip 13, and an EMC layer 20 encapsulates the back side of the substrate 11. At this time, a structure constituting the ISP bare chip and the EMC layer 20 is thinner than the conventional ISP package 103 or the ISP package 3 according to the first embodiment of the present invention, thereby reducing the height of the camera module according to the second embodiment of the present invention.

According to the second embodiment, the camera module comprises the image sensor module, a housing 15, a hard packing 18, a lens 17, a knob 19, a filter 14, and an FPCB 16.

The hard packing 18, engaged with a screw, is positioned inside of the housing 15, covering the upper portion of the image sensor module, and the lens 17 is positioned in the hard packing. Similarly to the first embodiment, the knob 19 covers an end of the hard packing, the filter 14 is positioned inside of the housing, and the FPCB 16 is connected to the back side of the substrate 11. At this time, the height h3 of the housing 15 of the camera module is higher than the height h2 of the housing of the first embodiment. However, the height of the camera module according to the second embodiment is lower than that of the first embodiment because the structure, consisting of the EMC layer 20 for encapsulating the back side of the substrate 11 and the ISP bare chip, is thinner than the ISP package 3 according to the first embodiment. Therefore, the camera module according to the second embodiment of the present invention has a lower height than a conventional camera module shown in FIG. 1.

The process of fabricating the image sensor module according to the second embodiment comprises the steps of forming a hole at the center of a substrate 11; inserting an ISP bare chip, which is thinner than an ISP package, into the hole of the substrate 11 and detachably adhering tape to the upper side of a resulting structure; conducting a wire-bonding on the back side of the substrate 11 and encapsulating the back side of the substrate 11 with an epoxy molding compound layer; removing the tape from a structure consisting of the image signal process bare chip and the substrate 11; and attaching an image sensor 12 to the upper side of the image signal process bare chip 13 and conducting a wire-bonding. At this time, the shape of the ISP bare chip and the substrate subjected to the wire-bonding is shown in the EMC layer as in FIG. 3.

In other words, the ISP bare chip in which an ISP substrate is removed from the ISP package is attached to the substrate 1, and the lower side of the ISP bare chip is coated with a liquid epoxy molding compound and solidified, thereby reducing the thickness of the ISP bare chip by a total thickness of the ISP substrate and the substrate, thereby reducing the height of the camera module of the second embodiment while constantly maintaining a desired distance between the image sensor and the lens (the thinner the ISP package is, the higher the production cost of the ISP package is). Additionally, because the EMC layer of the second embodiment of the present invention is coated on the lower side of the ISP bare chip in a liquid state, the EMC layer of the present invention can be thinner than the EMC layer of a conventional ISP package.

According to the third embodiment of the present invention, the image sensor module comprises a substrate 21 with a hole positioned at the center thereof; an FPCB 26 attached to the back side of the substrate 21; an ISP package 23 attached to the back side of the FPCB 26; and an image sensor 22 mounted in the hole of the substrate 21.

In addition, the camera module is provided. This camera module comprises the image sensor module according to the third embodiment; a housing 25 covering the upper portion of the image sensor module; a hard packing 28, engaged with a screw, positioned inside of the housing; a lens 27 positioned inside of the hard packing; knob 29 covering an end of the hard packing; and a filter positioned inside of the housing.

The process of fabricating such an image sensor module according to the third embodiment comprises the steps of forming a hole at the center of a substrate 21; attaching an FPCB 26 to the back side of the substrate; attaching an ISP package 23 to the back side of the FPCB 26; and adhering an image sensor 22 to the hole of the substrate with the use of an adhesive and conducting a wire-bonding.

The height h4 of the camera module according to the third embodiment of the present invention is higher than the height h2 of the camera module according to the first embodiment by the FPCB 26, but lower than the height h1 of a conventional camera module.

As described above, the image sensor module and the camera module of the present invention are advantageous in that the image sensor module applied to the camera module can obtain a sufficient brightness while a desired distance between the lens and the image sensor is properly maintained to secure a desired focal distance, and so a compact digital camera can be produced by using the camera module of the present invention.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. An image sensor module, comprising:
a substrate having a hole positioned at the center thereof;
an image signal process package attached to a back side of the substrate; and
an image sensor mounted in the hole of the substrate.

2. A camera module, comprising:
an image sensor module;
a housing covering an upper portion of the image sensor module;
a lens positioned inside of the housing;
a filter positioned inside of the housing; and
a flexible printed circuit board connected to a back side of a substrate of the image sensor module, said image sensor module, comprising:
the substrate having a hole positioned at the center thereof;
an image signal process package attached to a back side of the substrate; and
an image sensor mounted in the hole of the substrate.

3. A process of fabricating an image sensor module, comprising the steps of:
forming a hole at the center of a substrate;
attaching an image signal process package to a back side of the substrate; and
adhering an image sensor to the hole of the substrate with the use of an adhesive and by conducting a wire-bonding.

4. An image sensor module, comprising:
a substrate having a hole positioned at a center thereof;
an image signal process bare chip mounted in the hole of the substrate; and
an image sensor positioned on an upper side of the image signal process bare chip and an epoxy molding compound layer encapsulating a back side of the substrate.

5. A camera module, comprising:
an image sensor module;
a housing covering an upper portion of the image sensor module;
a lens positioned inside of the housing;
a filter positioned inside of the housing; and
a flexible printed circuit board connected to a back side of a substrate of the image sensor module, said image sensor module, comprising:
the substrate having a hole positioned at the center thereof;
an image signal process bare chip mounted in the hole of the substrate; and
an image sensor positioned on an upper side of the image signal process bare chip and an epoxy molding compound layer encapsulating the back side of the substrate.

6. A process of fabricating an image sensor module, comprising the steps of:
forming a hole at the center of a substrate;
inserting an image signal process bare chip into the hole of the substrate and detachably adhering a tape to an upper side of a resulting structure;
conducting a wire-bonding on a back side of the substrate and encapsulating the back side of the substrate with an epoxy molding compound layer;
removing the tape from a structure consisting of the image signal process bare chip and the substrate; and
attaching an image sensor to an upper side of the image signal process bare chip and conducting a wire-bonding.

7. An image sensor module, comprising:
a substrate having a hole positioned at the center thereof;
a flexible printed circuit board attached to a back side of the substrate;
an image signal process package attached to a back side of the flexible printed circuit board; and
an image sensor mounted in the hole of the substrate.

8. A camera module, comprising:
an image sensor module;
a housing covering an upper portion of the image sensor module;
a lens positioned inside of the housing; and
a filter positioned inside of the housing, said image sensor module, comprising:
a substrate having a hole positioned at the center thereof;
a flexible printed circuit board attached to a back side of the substrate;
an image signal process package attached to a back side of the flexible printed circuit board; and
an image sensor mounted in the hole of the substrate.

9. A process of fabricating an image sensor module, comprising the steps of:
forming a hole at the center of a substrate;
attaching a flexible printed circuit board to a back side of the substrate;
attaching an image signal process package to a back side of the flexible printed circuit board; and
adhering an image sensor to the hole of the substrate with the use of an adhesive and by conducting a wire-bonding.
